(19) United States
(12) Patent Application Publication
(10) Pub. No.: US 2013/0226664 A1
(43) Pub. Date: Aug. 29, 2013

(54) Dynamic Market Polling and Research System

(71) Applicant: 1B3Y, LLC, (US)

(72) Inventor: Keith Rinzler, Sandy Springs, GA (US)

(73) Assignee: 1B3Y, LLC, Atlanta, GA (US)

(21) Appl. No.: 13/781,744

(22) Filed: Feb. 28, 2013

Related U.S. Application Data
(60) Provisional application No. 61/604,988, filed on Feb. 29, 2012.

(51) Int. Cl. G06Q 30/02

(52) U.S. Cl. CPC G06Q 30/0203
USPC 705/7.32

(57) ABSTRACT

The invention may be embodied in a compensation driven permission marketing and polling system referred to as an instant response system. The instant response system directly targets market polling communications to precise demographic, geographic, psychographic and/or keyword-associated audiences to empower businesses with sophisticated, immediate and effective targeted marketing and research at a fraction of the traditional expense. Dynamic polling techniques are used to automatically adjust polling demographics to match polling results to demographic objectives with minimum number of polling responses and reduce the cost of market surveys. Social media links to member profiles encourage self-generating membership growth and direct, interactive links to member profile data, such as member location tracking and survey compensation posting on the member's social media.

### REFERENCE TO RELATED APPLICATION

This application claims priority to U.S. Provisional Patent Application Ser. No. 61/604,988 entitled “Systems and Methods for Collecting Marketing and Polling Data, filed Feb. 29, 2012, which is incorporated by reference.

### TECHNICAL FIELD

The present invention relates to electronic data collection systems and, more particularly, to a dynamic permission-based market polling and research system incorporating per-response member survey compensation, social media interfacing, and dynamic polling to produce desired demographic results with the minimum number of member requests.

### BACKGROUND OF THE INVENTION

Direct marketing is a $150+ billion industry, while market research and polling account for another $40+ billion each year. Increasing use of online commerce and social media creates new opportunities and presents new challenges for direct marketing and market research. Cost effective direct marketing and market research requires effective and efficient techniques for identifying the most appropriate target audience each particular direct communication project and ensuring that the direct communication recipients actually read the polling or marketing information delivered to them. Properly identifying and motivating the target audience is often more important, and expensive, than locating raw address data to work with. While social media has experienced tremendous growth and contains a wealth of information concerning potential target audiences, direct marketing systems have not been developed to leverage this resource to advance market research and polling objectives.

Effective advertising and market research continue to be the keystones of a successful business. Despite continuing efforts to utilize online resources effectively, prior approaches to online market research and polling have been highly inaccurate with cost-prohibitive technical barriers preventing more accurate results. In addition, prior attempts to incorporate online resources into advertising have experienced very poor click-through and response rates. Existing technology for incorporating social media into market research and polling remains cumbersome and inaccurate. As a result, the current lack of affordable and effective direct marketing and research platforms presents a major barrier to entry for many companies, especially small and medium-sized businesses, which cannot afford to expend the vast sums necessary to reach their target audiences.

There is, therefore, a continuing need for improved online market research and polling systems and, more specifically, market research and polling systems that more effectively utilize social media and other techniques to increase the effectiveness and decrease the cost of market research and customer polling.

### SUMMARY OF THE INVENTION

The present invention meets the needs described above in a compensation driven permission marketing and polling system referred to as an instant response system. The instant response system directly targets market polling communications to precise demographic, geographic, psychographic and/or keyword-associated audiences to empower businesses with sophisticated, immediate and effective targeted marketing and research at a fraction of the traditional expense. Dynamic polling techniques are used to automatically adjust polling demographics to match polling results to demographic objectives with minimum number of polling responses and reduce the cost of market surveys. Social media links to member profiles encourage self-generating membership growth and direct, interactive links to member profile data, such as member location tracking and survey compensation posting on the member's social media.

The instant response system provides the responding members with complete anonymity while collecting a large database of customer profile and polling information, which is formatted into a searchable database and made available for demographic market research. The per-response polling compensation model provides an instant, fully transparent contractual arrangement that motivates member survey participation and robust permission to member profile information by those members interested in generating income though survey participation. Including the fact of membership in the instant response system and the amount of compensation received on the member's social media fosters viral growth in system membership through social media exposure.

The dynamic polling system utilizes member ranking parameters to meet demographic polling objectives within specified survey durations with minimum survey responses. The member ranking parameters include customer factors and system factors to simultaneously advance customer survey objectives and instant response system development objectives through dynamic polling administration. Similarly, social media interfaces, both uploaded from member social media (e.g., customer profile and location tracking information) and downloaded to the member social media (e.g., survey compensation posting) also simultaneous advance customer survey objectives and instant response system development. A high level of permission-based member participation is developed through ongoing polling motivated by per-response compensation. This allows the instant response system to self-generate in a viral manner to create a large scale, easily searchable, ever improving demographic database of highly relevant market research information. This further motivates customer survey participation as well as providing an independent market research resource.

Taken together, self-generating membership participation and self-generation market research database development aspects of the instant response system fundamentally improves upon the conventional approach to market polling and research. In addition, the ability of the instant response system to simultaneously and dynamically consider both customer factors and system factors in target audience selection produce further improves over the conventional approaches. The consideration and direct linking of member social media to the polling and market research system provides further advancement over conventional approaches to market poling and research.

In view of the foregoing, it will be appreciated that the present invention provides an improved market polling and research. The specific systems and techniques for accomplishing the advantages described above will become apparent from the following detailed description of the embodiments and the appended drawings and claims.

### BRIEF DESCRIPTION OF THE DRAWINGS

FIG. 1 is a block diagram of an instant response system.

FIG. 2 is a block diagram of member interaction and demographic market research in the instant response system.

FIG. 3 is a logic flow diagram of a dynamic polling technique in the instant response system.

FIG. 4 is a conceptual illustration of a customer survey request in the instant response system.

FIG. 5 is a conceptual illustration of dynamic polling progression in the instant response system.

FIG. 6 is a logic flow diagram for a weighting algorithm used for dynamic polling in the instant response system.

FIG. 7 is a conceptual of weighting system factors and customer factors in the weighting algorithm.

FIG. 8 is a conceptual for progressively changing the weighting of system factors and customer factors in the weighting algorithm.

FIG. 9 is a conceptual illustration of a customer survey request with multivariate relationships in the instant response system.

FIG. 10 is a logic flow diagram of a dynamic polling technique for a customer survey request with multivariate relationships in the instant response system.

FIG. 11 is a conceptual illustration of a first categorized dynamic poll iteration with multivariate relationships in the instant response system.

FIG. 12 is a conceptual illustration of a second categorized dynamic poll iteration with multivariate relationships in the instant response system.

FIG. 13 is a conceptual illustration of the comparison and selection of a best result for a categorized dynamic poll iteration with multivariate relationships in the instant response system.

### DETAILED DESCRIPTION OF THE EMBODIMENTS

The present invention may be embodied in a compensation driven permission marketing and polling system that utilizes per-response member survey compensation, social media interfacing, and dynamic polling to produce desired demographic results with the minimum number of member requests. An illustrative example of the technology is referred to as the “1Q instant response system” or more briefly as the “1Q system.” While the 1Q system may be used for a wide range of objectives, such as direct marketing, market research surveys, polling, focus groups, and any other marketing or research objective relying on bulk responses to direct member communications, the description of system refers to a member survey (also called polling) example as an illustrative application of the technology. It will be appreciated that the 1Q system can be readily adapted to other direct response objectives by changing the content of the member communications.

The 1Q instant response system is permission based through a membership system in which members agree to participate by providing short turn-around anonymous responses to electronic polling requests in exchange for per-response compensation. Customers utilize the instant response system to conduct surveys (also referred to a polls) of the members in exchange for a per-response compensation. The provider of the instant response system (“1Q system operator”) earns the difference between the fees received from the customer and the payments made to the member as compensation for operating the instant response system. For example, the customers may pay two dollars for each response received, while the members may be paid one dollar for each response provided. While other types of fees and payments may be utilized, the per-response compensation model is easy to understand and has been found to be highly effective in motivating participation by both members and customers on a basis that is transparent and easily measured and tracked by all involved.

In order to participate in the compensation system, each member enters into a marketing participation agreement and provides the 1Q system operator with demographic information about the member, such as age, address, education, family, income, purchasing preferences, and so forth. The member is encouraged to provide greater levels of demographic data to increase the likelihood they will be selected to participate in surveys. While membership questionnaires may run the range from basic to highly involved, the 1Q system may only request a bare minimum of information, such as the member's name and phone number, along with authorization to obtain additional member profile information from their social media resources, such as Facebook. Members may also authorize 1Q to access and utilize information about the member from public resources, such as Equifax. Members are encouraged to enter advanced demographic information into their social media resources and may, for example, create a “1Q” section specifically designed to contain member supplied information intending that information to be used by 1Q to determine their suitability and desire to be in surveys relating to different areas of potential inquiry.

Advanced demographics may include information such as professional information, areas of professional interest, areas of recreational interest, areas of expertise, hobbies, family information, political affiliations, associations, automobiles, vacation locations, preferred reading materials, major products or services recently purchased, major products or services they intend to purchase in the near future, health information, etc. While 1Q will keep all the member's profile information and survey responses strictly confidential, all of this demographic information as well as their prior survey response history can be used to target the member for survey participation. Members are therefore motivated to provide higher levels of demographic information to increase the likelihood that they will be selected for polling based on the demographic data provided. The demographic data is contained in a member profile stored as part of the instant response system, where is can be used to target the member as a survey recipient. In this manner, the instant response system accumulates a great deal of demographic information about its members while simultaneously obtaining authorization to use this information for customer surveys and market research purposes.

Members are also encouraged to allow the 1Q system operators to automatically post whenever the member receives compensation from 1Q on their social media resource. Although the fact of compensation is considered to be an effective posting, additional compensation related information may be automatically posted if desired, such as the amount of compensation, the number of surveys, the duration of membership, and so forth. Members may also authorize advanced features such as “friend tracking” and “location tracking” so that the number of friends on their site and their geographical location may be used as survey selection criteria. The member may also authorize a survey compensation “hot link” to the instant response system where the amount of survey compensation paid to the member is continually updated by the instant response system. Posting the fact of the member's participation in the 1Q system and member's survey compensation on social media provides effective advertising for the 1Q system provider motivating others to join as members. These and other social media factors can be tracked and used as ranking parameters to increase the member's priority as a potential survey recipient, thereby increasing the member's income potential through survey participation.

The 1Q system utilizes a dynamic polling algorithm that allows the 1Q survey results to satisfy survey constraints and very closely match target demographics defined by a survey request with a minimal number of survey responses. The survey constraints and target demographics provided by the customers as part of the survey request are typically obtained from actual demographic resources. The 1Q dynamic polling algorithm allows the survey to “hone in” on the desired demographic results with a minimal number of survey requests by submitting the requests to members forming the target audience in a priority order, computing the residual target demographics as survey results roll in, and continually adjusting the target audience to match the residual target demographics as the survey progresses. This allows the 1Q system to iteratively narrow the target audience to those members having the increasingly precise demographics needed to meet the target demographics as the survey progresses toward completion.

While dynamically converging on the target demographics as described above, the 1Q system ranks the members in a priority order for inclusion in the poll using a number of weighting factors that take a number of factors into consideration in the weighting process. The weighting factors include a number of “system factors” that are considered beneficial to the 1Q system operator by encouraging membership growth and participation, along with a number of “customer factors” that are considered beneficial to completion of the survey with a minimum of requests by closely matching the target audience to the residual target demographics. The weighting is progressively shifted from system factors to customer factors as the survey progresses to meet both sets of objectives while fulfilling the survey request with a minimum number of survey requests.

The 1Q system may produce categorized surveys with multivariate relationships. Every poll specifies a number of demographic categories with defined criteria. To provide a simple example, a particular survey may specify age, geographic region, and ethnic race as demographic categories, with each category defining four criteria. A poll without multivariate relationships requires only that the overall survey results meet these demographic criteria. Multivariate relationships, on the other hand, specify the demographic results for the criteria within each category. Expanding the preceding example into a multivariate example, each “age” category has its own demographic complex of geography and race factors, each “geography” category has its own demographic complex of age and race factors, and each “rage” category has its own demographic complex of age and race factors.

Conducting a poll to closely match target demographics with multivartiate relationships is extremely challenging because the interrelating criteria result in a giant jigsaw puzzle requiring, for example, 5000 surveys to obtain the “right” 1000 responses that match the multivartiate relationships of the target demographics. There are no polling systems currently available that are designed to produce poll results that closely match target demographics with multivartiate relationships. To meet this challenge, the 1Q system includes a dynamic polling algorithm that matches target demographics with multivartiate relationships within a defined margin of error, or presents the best available results, though the dynamic polling procedure. For example, the 1Q system may alert the customer, and provide the best available response, when the member database is simply not large enough to precisely match the multivariate demographic makeup of a national poll for a country of interest within the desired margin of error. In addition, the 1Q system may alert the customer, and provide the best available response, when an attempt to converge on a specific multivariate demographic makeup, within a specific margin of error, reaches a specified maximum survey time or number or responses.

Additional features and objectives of the 1Q instant response system are described in the U.S. Provisional Patent Application Ser. No. 61/604,988 entitled “Systems and Methods for Collecting Marketing and Polling Data, filed Feb. 29, 2012, which is incorporated by reference. A specific example of the technology is further described below with reference to the appended figures, in which a survey (also referred to as a poll) is described as an illustrative example of the technology. Direct response sales, focus groups, political polls, and other direct response objectives may also be accomplished as a matter of design choice.

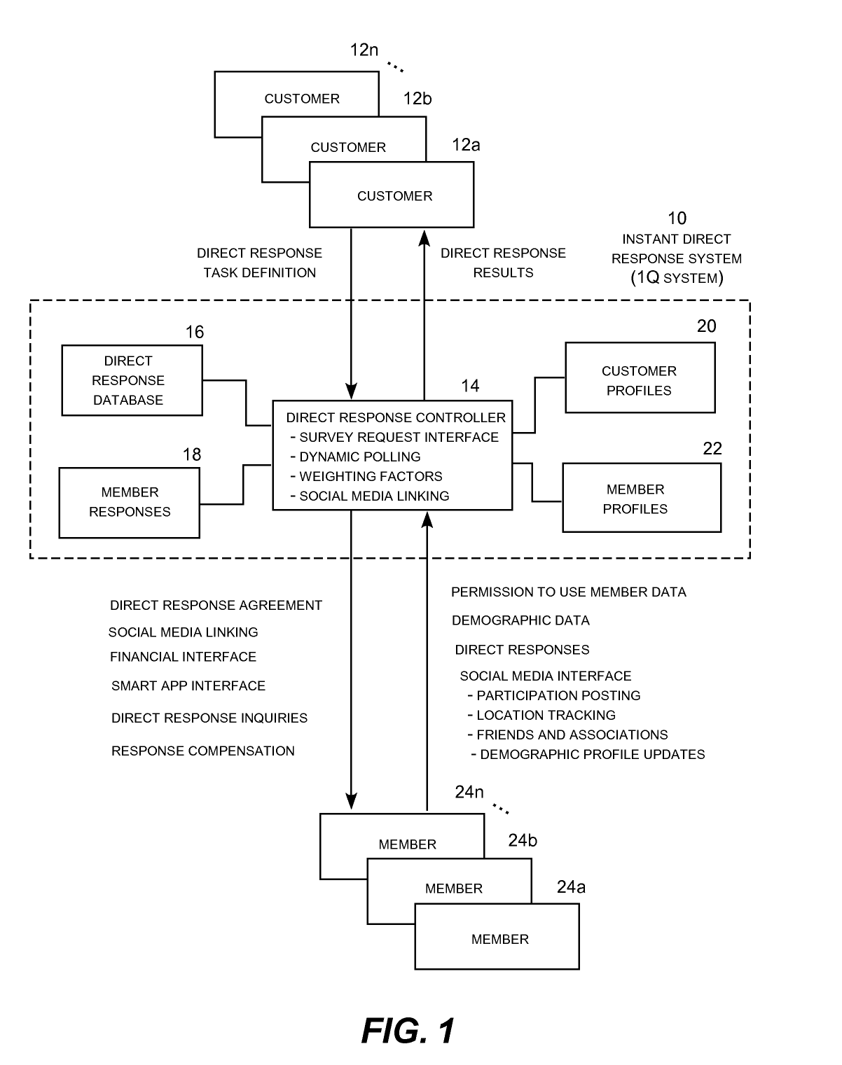

FIG. 1 is a block diagram of the 1Q instant response system 10, which is a compensation-based permission marketing system that allows customers 12a-n to conduct targeted surveys among the IQ system members 24a-n. The IQ system includes a direct response controller 14 that implements a survey request interface for receiving direct response task definitions from customers. FIG. 4 shows an example customer survey request 60. The direct response controller 14 also implements dynamic polling using weighting factors for executing direct response tasks, and social media linking with members. The direct response controller 14 also maintains a direct response database 16 containing complied survey response data and libraries containing member responses 18, customer profiles 20, and member profiles 22. Market research customers may be provided access to the direct response database 16, which includes compiled member response and demographic data without identifying the specific members or customers involved, typically on a fee basis for the purpose of conducting market or other types of analyses using the data collected and maintained by the 1Q system.

Although any desired compensation model may be employed, the preferred compensation model is an instant, per-response compensation model in which the customer pays an established per-response fee (e.g., two dollars per survey response), each member receives an established per-response payment (e.g., one dollar per response), and the 1Q system operator retains the balance as compensation for operating the 1Q system and servicing the survey requests. The instant, per-response compensation model provides the advantages of being extremely transparent, easy to understand, and easy to administer. The per-response rates may be maintained at low levels (e.g., single dollar levels) to encourage high system utilization and participation rates through short, highly targeted survey requests. Customers are encouraged to utilize the 1Q system repeatedly with multiple, highly targeted, short turn-around survey requests, while members are encouraged to provide detailed demographic information, remain connected and respond quickly and reliably to survey requests to increase their income earned through survey participation.

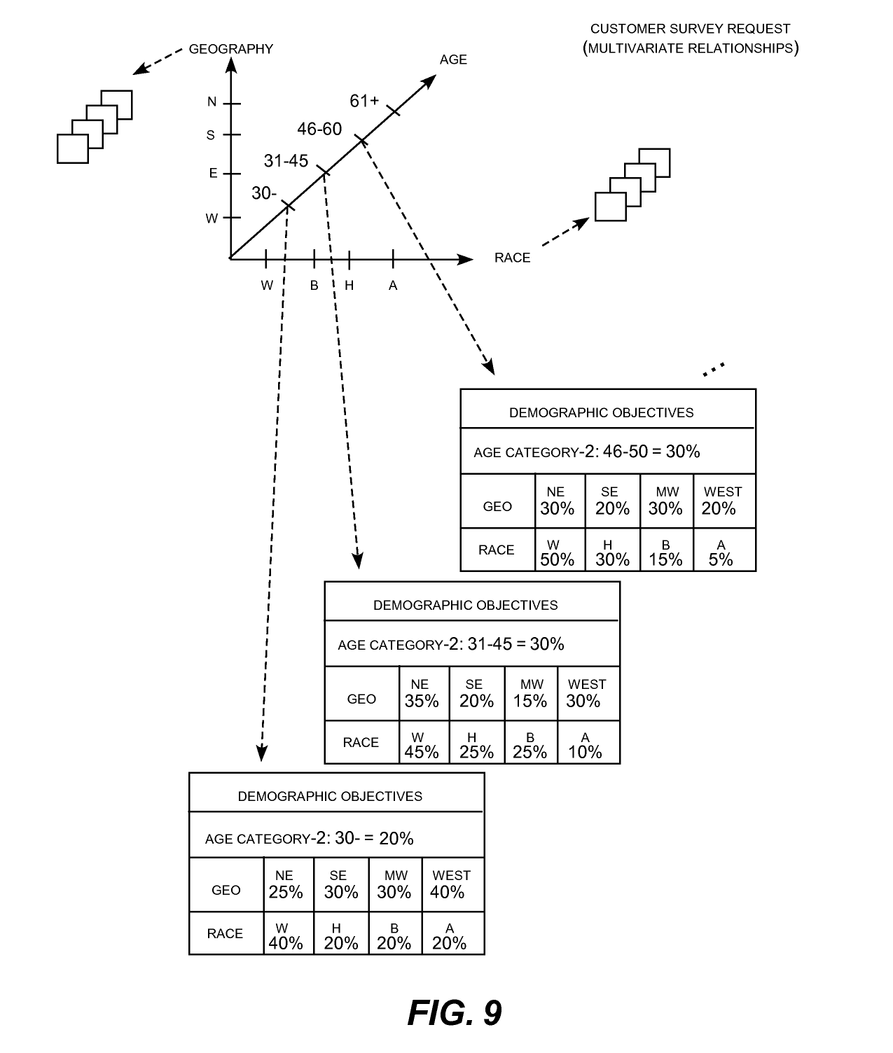

The customers input direct response task definitions (e.g., survey requests) into the 1Q system 10 and receive the direct response results (e.g., survey or poll responses with associated demographic information) from the 1Q system. The 1Q system 10 provides a menu-driven user interface that allows customers to enter the direct response task definitions into the 1Q system through an online connection. A survey or poll will be used as an example of a direct response task, although other types of direct response communications may be conducted with the 1Q system. The direct response task definition typically includes the specific questions to be directed to the target audience of members as well as survey constraints, poll parameters, and target demographics. Survey constraints typically define the scope of qualified respondents (target audience of members), such as geographical location and subject matter qualifications (e.g., survey participants to include 2011-2012 new home purchasers in the United States; tennis players in the Southeast United States, and so forth as determined by the customer conducting the poll). Poll parameters typically control the operation of the poll to limit the cost or time involved (e.g., terminate upon 30 minutes or 2,000 survey responses). Target demographics typically establish the desired survey response demographics along one or more categories, each specifying several criteria with specific values. A simplified example of a survey request provided to illustrate the principles of the inventions is shown in FIG. 4. For a multivariate poll, the customer may also define the more complex situation involving multivariate relationships among the demographic categories as shown in FIG. 9. A multivariate poll definition may also include a desired margin of error for considering the poll to have reached a successful conclusion, as described in greater detail with reference to FIGS. 9-13.

When setting up the survey requests, customers may also be able to set certain other operational parameters for the survey, such as the initial query size, iteration time, maximum number of iterations, maximum number of survey requests, dynamic weighting profile, and so forth. These operational parameters may alternatively be under the control of the 1Q system administrators through a system administration interface, or a combination of customer and system operator control may be enabled, as desired.

The 1Q system 10 creates, maintains, updates and fulfills a contractual, permission-based, compensation-based, and electronically linked relationship with its members 24a-n. This interconnected and interactive relationship allows the system to send polls only to those members who have consented to participate in polls, expect to do so for the agreed compensation, and meet the survey criteria which may involve having a particular demographic quality or interest associated with the subject matter of the poll. The members are motivated to participate in the polls and provide a high level of profile data and corresponding permission to use that data to increase their potential income from survey participation. The 1Q member relationship begins with a direct response agreement, in which the member contractually authorizes the 1Q system to use the information posted on the member's social media resource (e.g., Facebook) to be used to qualify the member for survey participation. The member also agrees provide survey responses in exchange for the set per-response payment (e.g., one-dollar per response). The member also provides demographic data for use in directing polls to the member and may authorize the 1Q system to obtain additional, updated information going forward from their social media resource and potentially from other locations, such as Equifax or other information resources. The member may also create a dedicated 1Q section on their social media where they enter and update information intending that information to be used to determine their suitability for 1Q surveys in order to increase their exposure and availability for survey participation. The member may also authorize active social media linking including GPS location tracking, direct 1Q posting of survey compensation on the member's social media, access to demographic updates from the member's social media, access to the member's friends and associations included on the member's social media, participation in 1Q notification programs via a smartphone app (typically involving prompting the member for survey participation or permission allowing the member to voluntarily increase survey participation), and so forth.

The 1Q system operator performs system implementation functions, as appropriate, including administering the direct response agreement, enabling the social media links with the members, sending the member the smartphone app, creating a financial interface with the member's designated financial institution (e.g., Paypal), sending the member polls, paying the agreed compensation when the member responds while the survey is still open, and updating the compensation positing. The 1Q system operator may also prompt the member to participate in polls and update their permissions and profile data through the smartphone app.

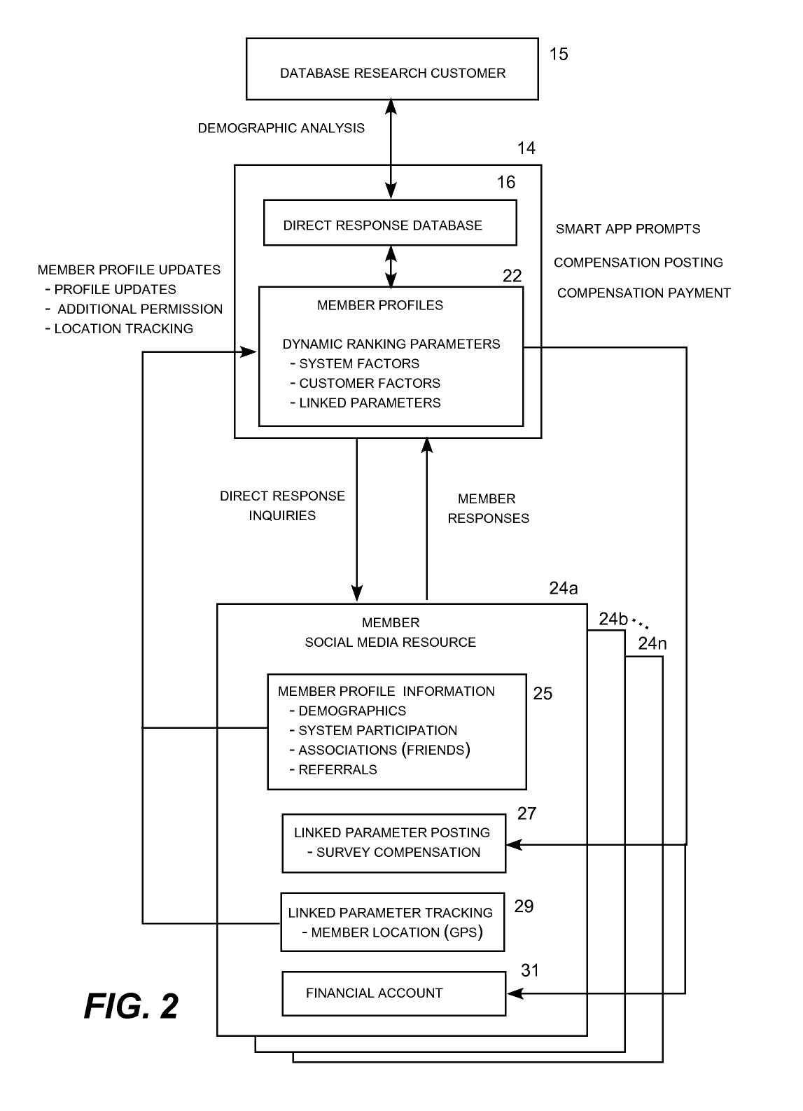

FIG. 2 is a block diagram of the linked member and database research customer interaction with the 1Q direct response controller 14 The member interaction may include interfacing with the member's social media, a smartphone app, and the member's account with a financial institution. The 1Q system sends the member prompts over the smartphone app, sends the member surveys over email, text or phone, electronically pays the member for survey responses, updates compensation positing on the member's social media, and updates the member's. In particular, update a “hot linked” posting field 27 on the member's social media, and make payments to the member's financial account 31. The 1Q system may access member profile information 25 maintained by the member on social media obtain location tracking data 29 from the member's social media. The 1Q system maintains and continually updates the member profiles 20 on the 1Q system, which may include updating the member demographic data, additional permissions, and location tracking. The 1Q system uses this information to rank the member for survey participation and weighting factors and to update the linked parameters. The 1Q system also consolidates the (anonymous) poll response data into the direct response database 16, which may be made available to a database research customer 15. This high level of automatic electronic interaction, which is motivated by the 1Q business model and operational technology but implemented largely through member and customer action using the system, allows the 1Q system to attract new members, service new surveys, and grow member profiles and permissions in a largely autonomous manner as the 1Q system gains exposure and increasing use.

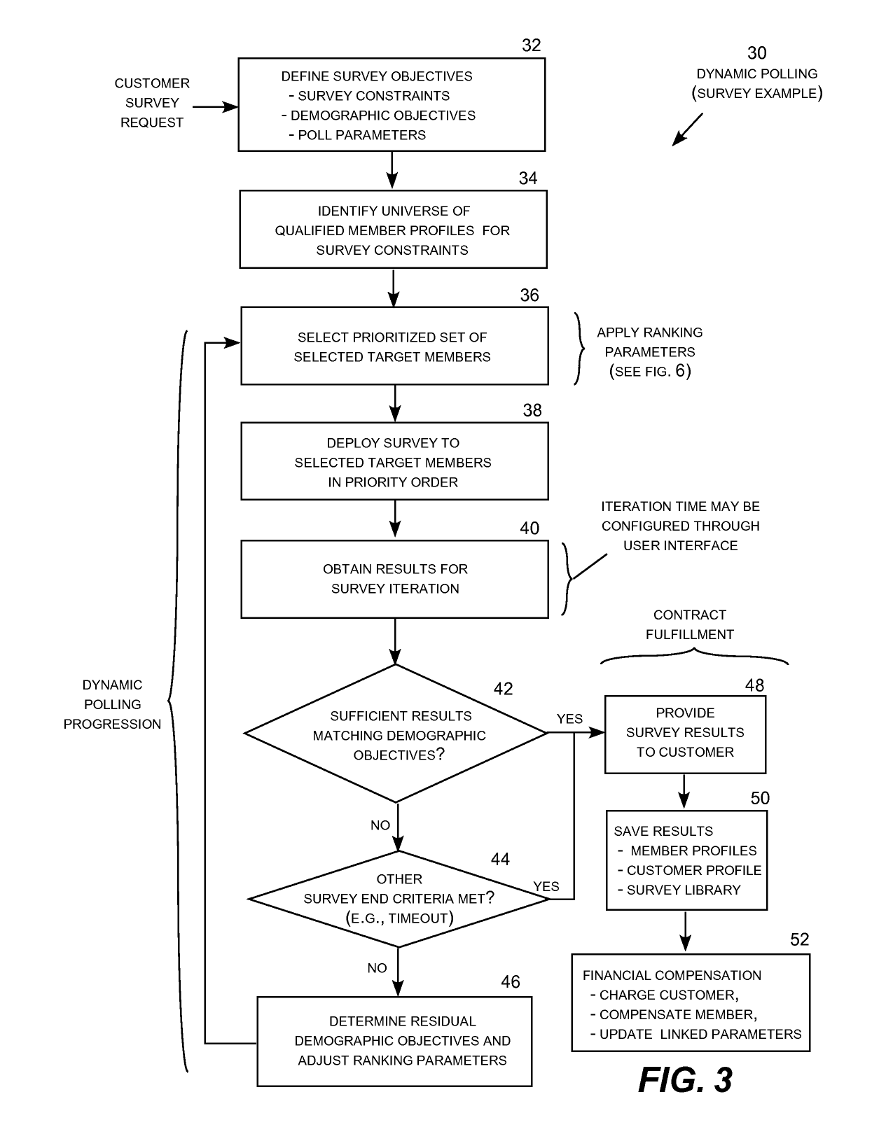

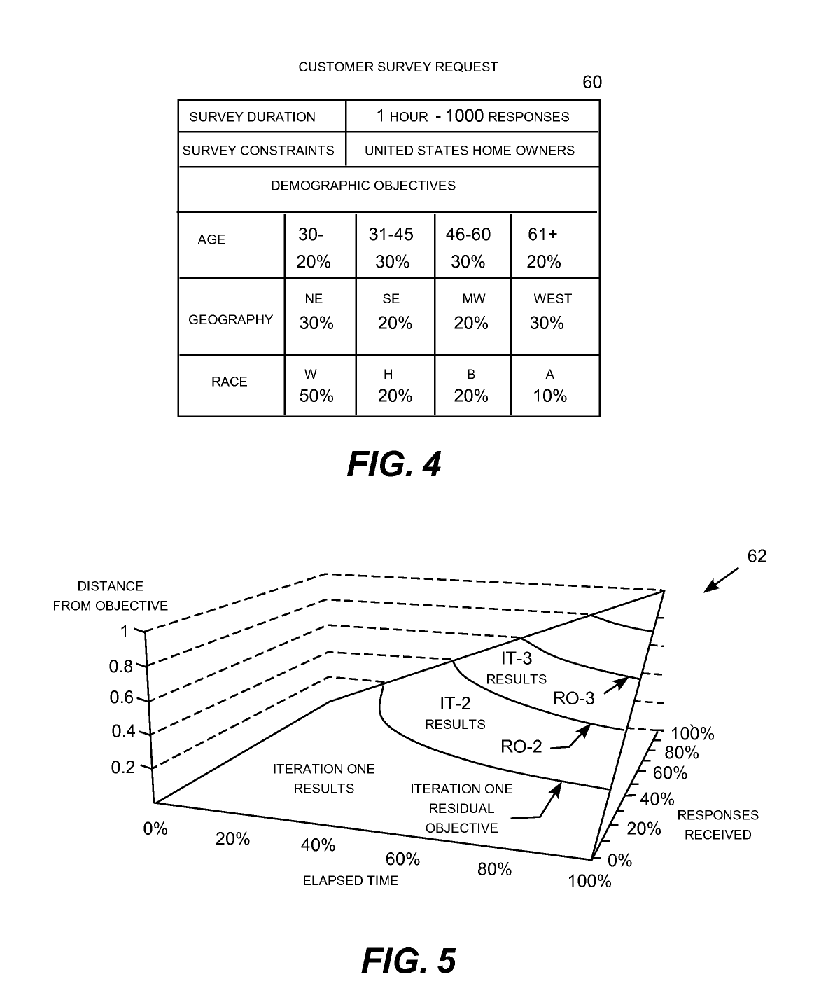

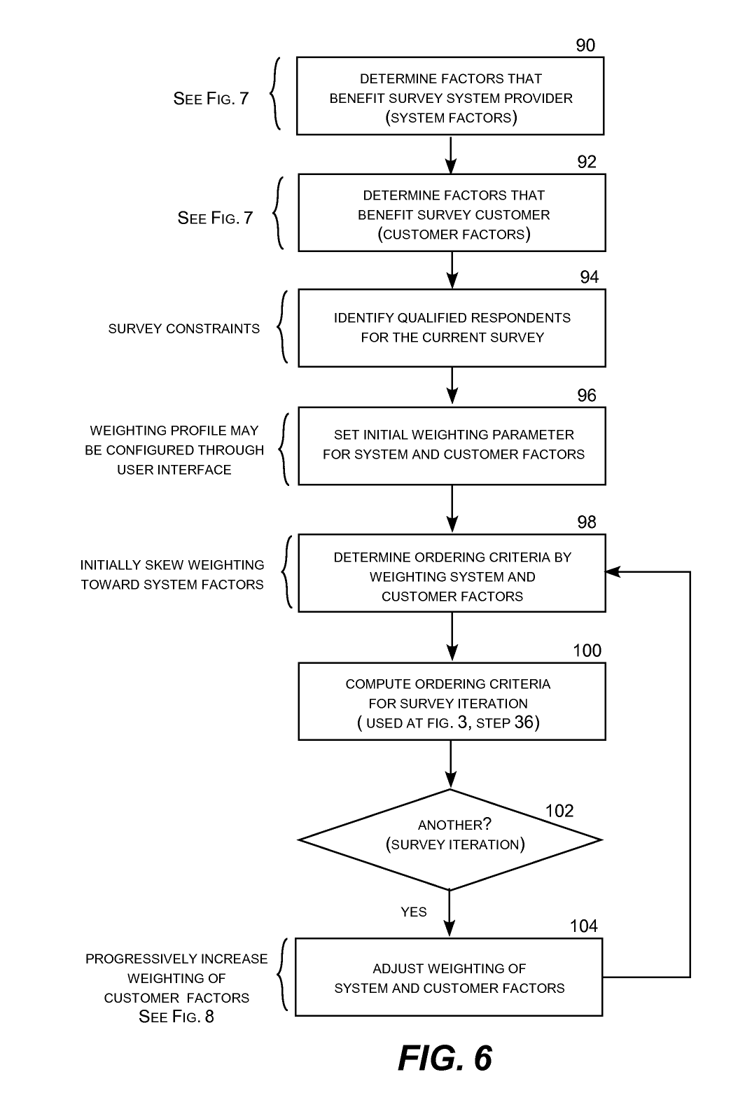

FIG. 3 is a logic flow diagram of a dynamic polling technique in the instant response system, using a survey example 30 to illustrate the functionality. In step 32, the 1Q system receives a customer survey request, which defines the survey objectives typically including survey constraints identifying qualified survey respondents, the target demographic objectives, and poll parameters used to control the operation and termination of the poll. Step 32 is followed by step 34, in which the 1Q system identifies the target audience of members for the survey, which may be thought of the universe of qualified member profiles that meet the survey constraints. The 1Q system then applies a dynamic polling progression as summarized in steps 36-46 to complete the survey request. Once the survey closes, the 1Q system implements contract fulfillment as summarized in steps 48-52.

Step 34 is followed by step 36, in which the 1Q system prioritizes the target audience of members based on weighting factors, which are described in more detail with reference to FIG. 6. Step 36 is followed by step 38, in which the 1Q system deploys the survey inquiry to the target audience in the priority order to an initial increment of members, which may be established as an operating parameter by the 1Q system administrator or by the customer as part of the survey request. Step 38 is followed by step 40, in which the 1Q system receives survey responses during an iteration period, which may also be established as an operating parameter by the 1Q system administrator or by the customer as part of the survey request. Step 40 is followed by step 42, in which the 1Q system determines whether the survey results match the demographic criteria established by the survey request. If the survey results do not yet match the demographic criteria established by the survey request, the “NO” branch is followed to step 44, in which the 1Q system determines whether another survey end criteria has been met, such as a timeout duration or maximum number of requests, which again may be established as operating parameters by the 1Q system administrator or by the customer as part of the survey request.

If a survey end criteria has not been met, the “NO” branch is followed to step 46, in which the 1Q system determines a residual demographic objective, adjusts the ranking parameters (see FIG. 6), and re-prioritized the remaining members of the target audience for another survey iteration. The dynamic polling algorithm then loops from step 46 to step 36 for another survey iteration. Additional iterations are then performed to hone in on the target demographics while adjusting the weighting factors to help meet the objectives associated with the weighting factors as the polling algorithm dynamically converges on the desired result. FIG. 5 illustrates is a graph 62 illustrating the dynamic polling algorithm. Each iteration produces iteration results (iteration one results, IT-2 results, IT-3 results, etc.), which are subtracted from the universe of qualified members for the poll to produce the residual objectives (iteration one residual objective, RO-2, RO-3, etc.) Each iteration brings the survey results closer to the target demographic results, with the weighting factors gradually shifting the weighting factors used to prioritize the remaining members of the target audience more toward the demographics of the residual objective with each iteration. This brings the poll toward convergence with a minimum of survey requests while also accomplishing the objectives reflected in the weighting factors.

Returning to FIG. 3, the survey comes to a close when the target demographics have been satisfied for the specified sample size (i.e., “YES” branch from step 42) or when another survey end criteria has been met, such as survey timeout or maximum number of requests (i.e., “YES” branch from step 44). Closing of the survey is followed by contract fulfillment beginning is step 48, in which the 1Q system provides the survey results to the customer that initiated the survey request. Step 48 is followed by step 50, in which the 1Q system saves the survey results by adding or reflecting the results in the member profiles 22, customer profiles 20, direct response database 16, and the member response library 18. The weighting factors used for member ranking and other system parameters may also be updated as desired to reflect the survey results. Step 50 is followed by step 52, in which the 1Q system fulfills the contractual requirements by charging the customer for the survey on a per-response basis, paying the responding members on a per-response basis, and updating the linked parameters, such as the fact of compensation posted on the responding members' social media resources.

It should be noted that the iteration time could potentially be set at any desired rate. Since the computing time will be negligible in comparison to human response times, the iteration rate could potentially be increased to the point where the algorithm updates the residual demographic objectives for each member response received, effectively determining the residual objective and issuing a single (or any other desired increment) new member request for each member response received after the initial request deployment. This granularity of the iteration may be adjusted and controlled by operating parameters based on system experience and poll objectives as experience with the 1Q system develops.

FIG. 6 is a logic flow diagram for a weighting algorithm used for dynamic polling in the instant response system, which feeds into step 36 of the dynamic polling methodology shown in FIG. 3. In step 90, the 1Q system determines “system factors” that are perceived, expected, or have been shown to benefit the 1Q system operator by encouraging growth of the membership base, survey response rates, convergence of the dynamic polling algorithm, diversity of the membership, expertise of the membership, the depth of permissions and demographic data provided by the membership, breadth of demographic factors included in the membership database, interconnectedness of the membership with the 1Q system, minimization of survey responses required to meet the survey criteria, notoriety of the 1Q system, and so further as the 1Q system operators may perceive those factors over time as experience develops with the system. A major objective of the system factors will be to foster viral growth of the member base and the attractiveness of the member base as a direct marketing and market research resource for the customer base. It should be noted here that the direct response database 16 as a market research tool, along with the robust and dynamically interconnected permission-based member base will ultimately drive the intrinsic value of the 1Q system. The system factors provide the 1Q system operators with “strings to pull” to measure, guide and dynamically foster the development of the 1Q system.

Step 90 is followed by step 92, in which the 1Q system determines “customer factors” that are perceived, expected or have been shown to benefit the customer who requested the survey principally by narrowing the residual audience to closely match the residual demographic required to converge the survey to meet the target demographic criteria with a minimum number of paid survey responses. Step 92 is followed by step 94, in which survey constraints are applied to the 1Q membership to identify the target audience (i.e., the qualified members based on the survey constraints) for the survey to be conducted. Step 94 is followed by step 96, in which the “system factors” and the “customer factors” are applied to the qualified member profiles using the associated weighting factors to prioritize the member profiles for inclusion in the survey in a prioritized order. Step 96 is followed by step 98, in which the initial member priority order is established by skewing the weighting factors toward the system factors for the early iterations. Step 98 is followed by step 100, in which the member priority order established by the weighting factors for the current iteration is utilized in the dynamic polling algorithm as step 36 of FIG. 3. Step 100 is followed by step 102, in which the 1Q system determines whether an additional survey iteration is to be conducted. If an additional survey iteration is to be conducted, the “YES” branch is followed to step 104, in which the weighting factors are adjusted, typically by progressively shifting the weighting parameters from system factors to customer factors with successive survey iterations. The weighting algorithm then loops to step 98, in which the 1Q system uses the refined weighting parameters to prioritize the remaining qualified members for the next survey iteration to satisfy the residual demographic objectives computed for the next iteration.

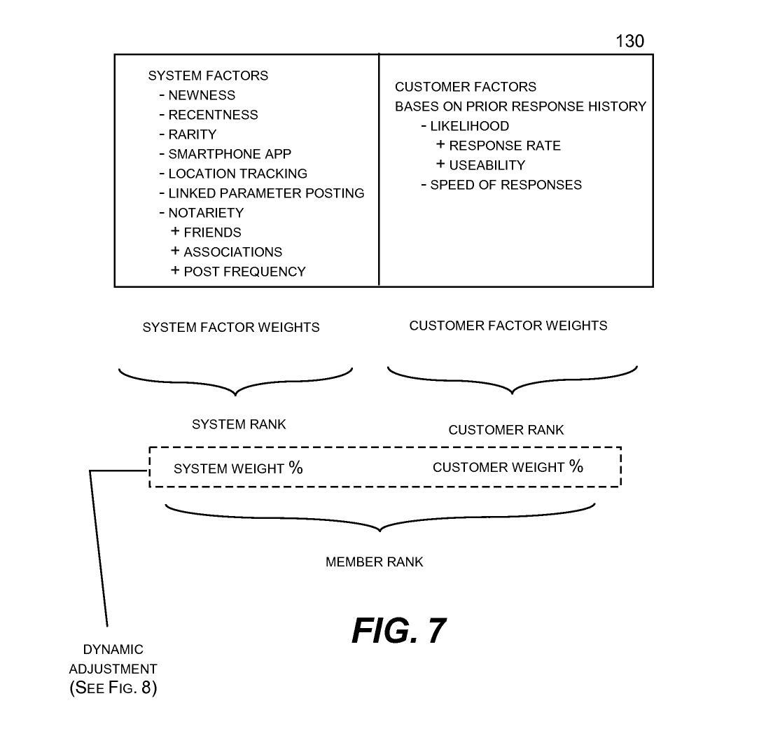

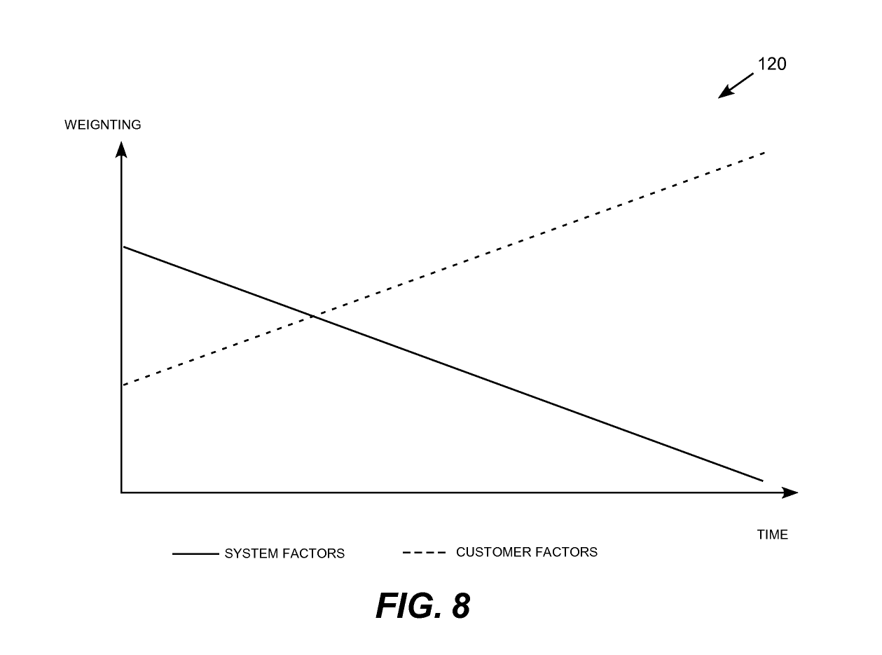

FIG. 7 is a chart 130 illustrating an example of system factors and customer factors. The system factors are ascertained for a member from the member's demographic information and combined to produce a system rank for the member. Similarly, the customer factors are ascertained for a member from the member's demographic information and combined to produce a customer rank for the member. The member's system rank is weighted by a system weighting parameter, and the member's customer rank is weighted by a customer weighting parameter, and the two components are combined to obtain the member's rank for the survey iteration.

The dynamic adjustment of the system and customer factors in the determination of the members' priority rankings are illustrated in the graph 120 shown in FIG. 8. The weighting of the system factors is initially relatively high, while the weighting of the customer factors is initially relatively low. This influence shifts over the course of subsequent iterations until the weighting of the system factors is relatively low, while the weighting of the customer factors is relatively high. This shift of influence from system factors to customer factors causes the poll to dynamically converge on the target demographics defined for the survey, as shown in FIG. 5.

It will be appreciated that FIG. 3 illustrates a straightforward dynamic poll procedure designed to converge on the target demographics in a linear manner as each survey iteration advances the result closer to the objective. The survey objective is more complex when multivariate relationships are specified as part of the demographic objectives. This situation is illustrated in FIG. 9, which shows a survey example with age, geographical region, and race categories as an example. Each age criteria has its own geographic and race profile. Similarly, each race criteria has its own age and geographic region profile; and each geographic region criteria has its own age and race profile. In this situation, the poll cannot be expected to converge on the target demographics are readily as a poll without multivariate relationships.

To address this situation, the survey constraints for a poll with multivariate relationships typically specifies a margin of error used to determine when a survey result is acceptably close to the target demographic profile with multivariate relationships. Any suitable statistical method may be used to compute the margin of error, such as computing the average difference percent difference of the poll result versus target criteria over the entire matrix of interrelated demographics. To obtain candidate polls to meet the target demographic profile with multivariate relationships, the 1Q system by forcing one of the categories to match the target demographic for that category by selecting the member responses to meet the preset criteria for the selected category. The 1Q system then computes the margin of error for the target demographic profile with multivariate relationships with the selected category set to the preset criteria by virtue of the member profiles selected for including in the poll results. This procedure can then be repeated with a different demographic category set to the preset criteria of the target demographic (preset category), with the margin of error computed for each analysis (margin of error for each reset category analysis). The resulting margins of error can then be compared and the lowest or best margin of error selected.

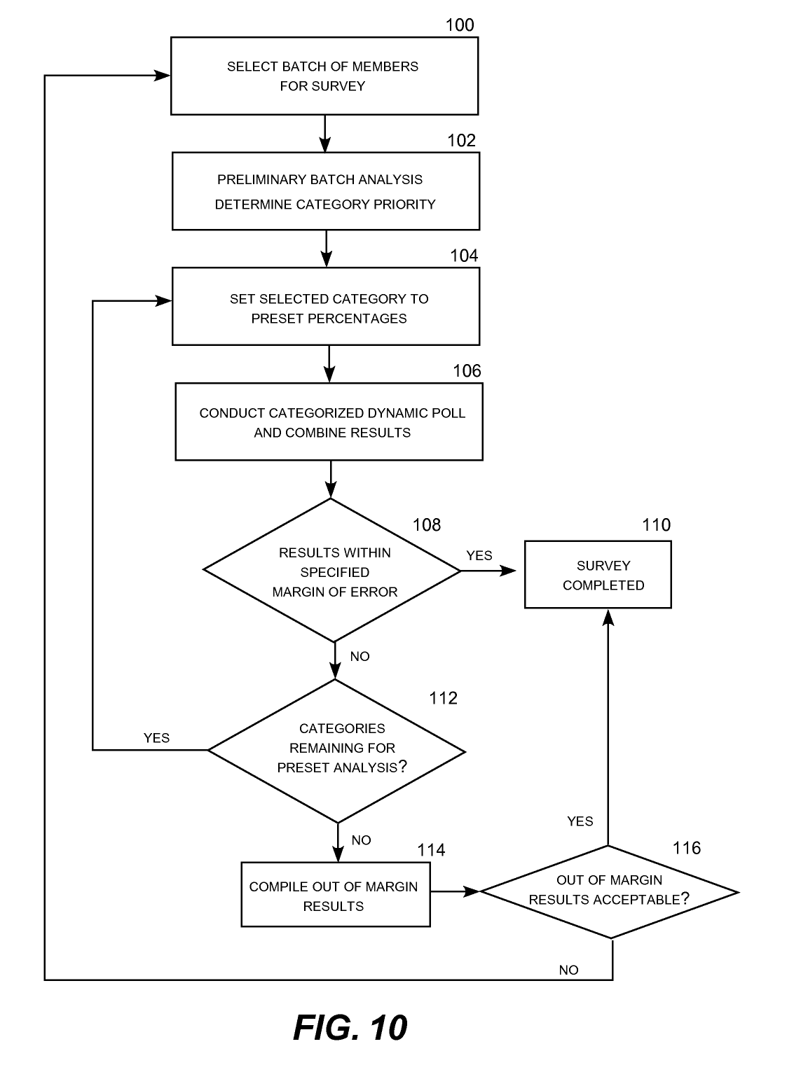

FIG. 10 is a logic flow diagram of a dynamic polling technique for conducting a poll to satisfy a customer survey request with multivariate relationships, as described above generally with reference to FIG. 9. This routine by be applied dynamically as part of the dynamic polling progression or as a post-processing analysis following the conduct of a dynamic poll in which a desired number of member responses have been obtained. In step 100, the 1Q system selects a batch of member responses or member profiles for batch analysis, typically corresponding to the number of member responses needed to satisfy the survey criteria for the poll under consideration. Step 100 is followed by step 102, in which the 1Q system conducts a preliminary batch analysis, for example by computing the statistical variance of the multivariate relationship among the member responses or profiles for each category domain in order to prioritize the categories for preset category analysis. Step 102 is followed by step 104, in which a first demographic category is set to the preset values provided by the survey target demographic objectives. Step 104 is followed by step 106, in which the dynamic poll is conducted (or, for the post-poll processing alternative, results from a previously conducted poll are retrieved). Step 106 is followed by step 108, in which the margin of error for the categorized analysis is computed. Step 108 is followed by step 110, in which the 1Q system determines whether the categorized analysis meets the target margin of error. If the categorized analysis meets the target margin of error, the “YES” branch is followed to step 110, in which the survey is considered to be successfully completed. If the categorized analysis does not meet the target margin of error, the “NO” branch is followed to step 112, in which the 1Q system determines whether another demographic category remains for categorized analysis. If another demographic category remains for categorized analysis, the YES” branch is followed to step 104, in which another poll (or post-poll processing analysis) is conducted with the next category in the priority order is preset to the criteria defined by the target demographic objective.

The analysis thus continues until one of the category analyses meets the margin of error or all of the categories have been analyzed as the preset category with none of the categorized analyses meeting the margin of error. If the analysis completes without any of the categorized analyses meeting the margin of error, step 112 is followed by step 114, in which the 1Q system determines (based on the survey parameters supplied by the customer) whether the survey should be terminated or continued at this point in view of the results falling outside prescribed margin of error. If the survey should be terminated at this point, the “YES” branch is followed to step 110 in which the survey is closed and the results provided to the customer. If the survey should not be terminated at this point, the “NO” branch is followed back to step 100 in which a new batch of member responses or profiles is selected, and the categorized analysis procedure is repeated with the new batch of members in another attempt to produce a survey meeting the multivariate relationships.

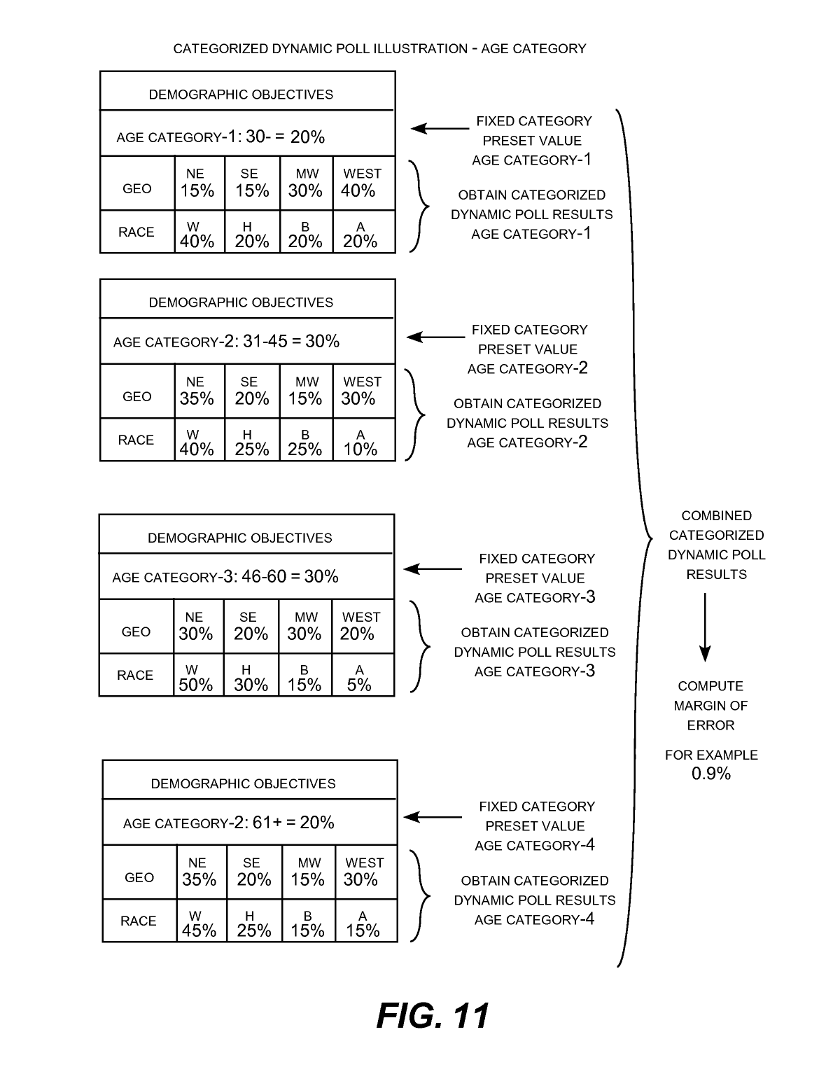

FIG. 11 illustrates an example of a categorized analysis, in which the member responses are selected to satisfy the preset criteria for the age category. For this example, a poll is conducted (or poll results are selected from previously obtained poll results) in which 20% of the respondents are age 30 or under, 30% of the respondents are age 31-4, 30% of the respondents are age 46-60, and 20% of the respondents are age 61 or above. With the age category preset to the target demographic criteria, the poll results are then obtained and computed for each age criteria, and the margin of error is computed for this categorized analysis (i.e., the categorized analysis with the age category preset). In this example, the categorized analysis with the age category preset results in a margin of error of 0.9%.

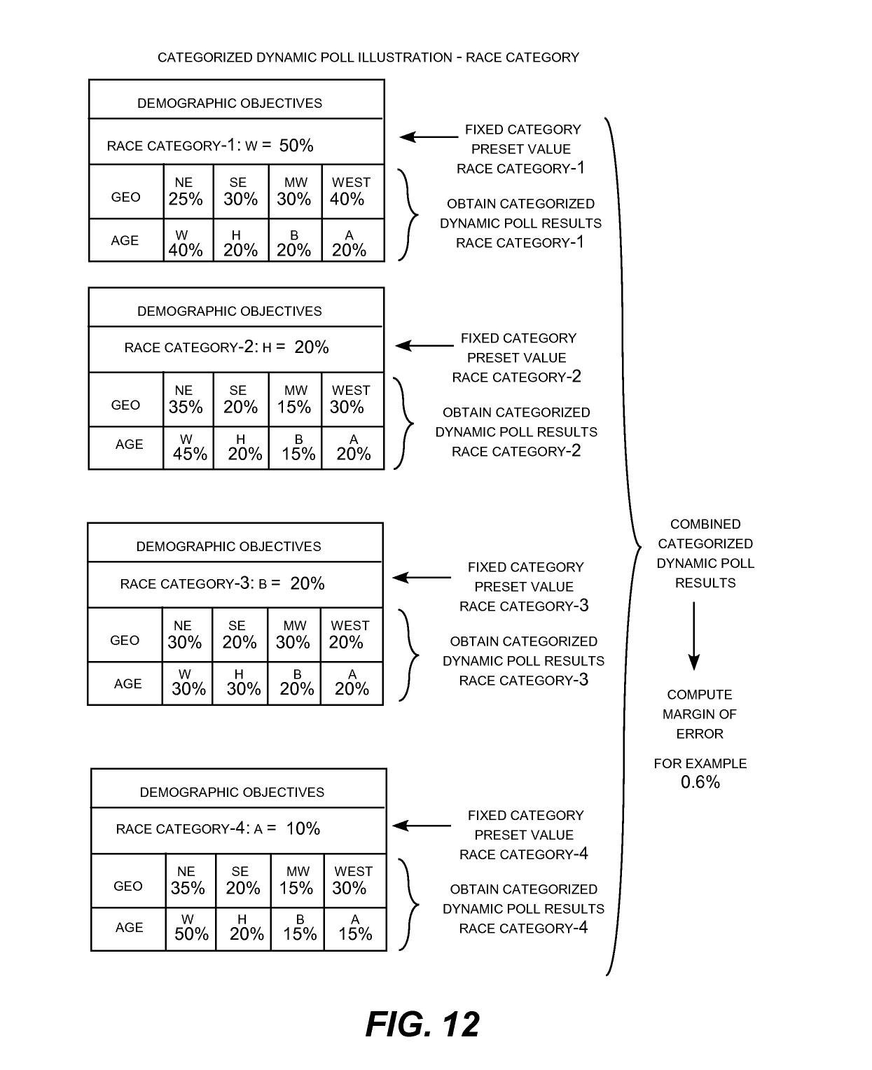

To continue with a specific analysis, FIG. 12 illustrates the example for the categorized analysis with the race category preset, in which the member responses are selected to satisfy the preset criteria for the race category. For this example, a poll is conducted (or poll results are selected from previously obtained poll results) in which 50% of the respondents identify as White (W), 20% identify as Hispanic (H), 20% identify as Black (B), and 10% identify as Asian (A). With the race category preset to the target demographic criteria, the poll results are then obtained and computed for each race criteria, and the margin of error is computed for this categorized analysis (i.e., the categorized analysis with the race category preset). In this example, the categorized analysis with the race category preset results in a margin of error of 0.6%.

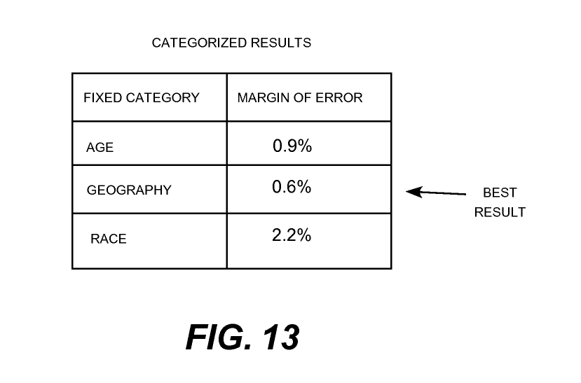

The categorized analysis can be repeated for each demographic category included in the survey request. In this example, three demographic categories (age, rage and geographic region) are included in the survey request. FIG. 13 shows the tabulation and comparison of the margins of error for the categorized analyses, in which the best result is selected as the categorized analysis producing the lowest margin of error.

Those skilled in the art will appreciate that. It will also be apparent how to. It will be further understood that the foregoing describes a preferred embodiment of the invention and that many adjustments and alterations will be apparent to those skilled in the art within the spirit and scope of the invention as defined by the appended claims.

The invention claimed is:

1. A dynamic permission-based market polling and research system, comprising:
a direct response controller operative to electronically interact with a plurality of customer systems associated with a plurality of customers and a plurality of member systems associated with a plurality of members;
the direct response controller further operative to maintain membership relationships with the members providing the direct response controller with permission-based access to member demographic data for the purpose of directing electronic surveys to the members and further providing electronic payment to the members on a per-response basis;
the direct response controller further operative to maintain paying customer relationships with the members providing for the delivery of surveys to the members an providing for receipt of payment from the customers on a per-response basis based on survey responses received from the members;
the direct response controller further operative to receive a survey request from a customer, direct the survey request to a target audience of the members, to receive responses to the survey from the members, direct the responses to the customer, charge the customer for the survey on a per-response basis, and pay members responding to the survey on a per response basis.

2. The market polling and research system of claim 1, wherein the direct response controller is further operative to obtain member demographic data from the members through electronic interaction with social media resources associated with the members pursuant to permission from the members, and to use the member demographic data to determine a target audience of members for the survey in a priority order.

3. The market polling and research system of claim 1, wherein the direct response controller is further operative to post a notice on a member's social media indicating compensation received by the member for participation in the survey.

4. The market polling and research system of claim 1, wherein:
the survey request identifies a target demographic objective for the survey;
the direct response controller is further operative to determine a residual demographic objective based on the target demographic objective and partial survey results; and
the direct response controller is further operative to adjust the priority order of the target audience of members to meet the residual demographic objective through subsequent survey requests.

5. The market polling and research system of claim 4, wherein the direct response controller is further operative to utilize weighting factors to determine and adjust the priority order of the target audience of members.

6. The market polling and research system of claim 5, wherein the weighting factors comprise system factors having a benefit to an operator of the direct response controller and customer factors having a benefit to the customer that requested the survey.

7. The market polling and research system of claim 6, wherein the direct response controller is further operative to shift the relative weight applied to the system factors versus the relative weight applied to the customer factors as the survey progresses.

8. The market polling and research system of claim 7, wherein the relative weight applied to the system factors decreases and the relative weight applied to the customer factors increases as the survey progresses.

9. The market polling and research system of claim 1, wherein at least a portion of the members provide permission for member location tracking through their social media resources and the direct response controller is further operative to determine the target audience for the survey based in part on the member location tracking.

10. The market polling and research system of claim 1, wherein at the direct response controller is further operative to prompt member participation in the survey, increased disclosure of member demographic data, or increased permission to access member demographic data through a smartphone app provided to the member.
